(19) United States
(12) Patent Application Publication
(10) Pub. No.: US 2026/0220196 A1
(43) Pub. Date: Jul. 30, 2026

(54) METHOD, APPARATUS, DEVICE, AND STORAGE MEDIUM FOR INFORMATION PROCESSING

(71) Applicants: Beijing Zitiao Network Technology Co., Ltd., Beijing (CN); LEMON INC., Grand Cayman (KY)

(72) Inventors: Xin Xie, Singapore (SG); Junyuan Qi, Beijing (CN); Xing LI, Los Angeles, CA (US); Junli Xian, Beijing (CN); Xin Yu, Beijing (CN); Fei Lu, Beijing (CN); Jingsheng Yang, Beijing (CN); Yang Liu, Beijing (CN); Yibing Zhu, Los Angeles, CA (US)

(21) Appl. No.: 19/142,924

(22) PCT Filed: Apr. 11, 2024
(86) PCT No.: PCT/CN2024/087285

§ 371 Date: Jun. 24, 2025

(30) Foreign Application Priority Data
Apr. 11, 2023 (CN) 202310382497.7
May 12, 2023 (CN) 202310539576.4

(51) Int. Cl. G06F 16/901

(52) U.S. Cl. CPC G06F 16/901

(57) ABSTRACT

According to embodiments of the disclosure, methods apparatuses, devices, and storage media for information processing are provided. In a method, first information input by a target object for a first processing entity is obtained, the first processing entity uniquely corresponds to the target object, based on the first information and historical interaction information between the target object and the first processing entity, and second information is generated as a reply of the first processing entity to the first information. In this way, by providing a unique corresponding processing entity for the target object (for example, a user or an organization), embodiments of the present disclosure may improve the quality of the reply generated by the processing entity.

This application claims priority to Chinese Patent Application No. 202310382497.7, filed on Apr. 11, 2023, and entitled “METHOD, APPARATUS, DEVICE, AND STORAGE MEDIUM FOR INFORMATION PROCESSING”, and this application further claims priority to Chinese Patent Application No. 202310539576.4, filed on May 12, 2023, and entitled “METHOD, APPARATUS, DEVICE, AND STORAGE MEDIUM FOR INFORMATION PROCESSING”, which are incorporated herein by reference in their entireties.

### FIELD

Example embodiments of the present disclosure generally relate to the field of computers, and in particular, to methods, apparatuses, devices, and computer-readable storage media for information processing.

### BACKGROUND

With the rapid development of Internet technologies, the Internet has become an important platform for people to obtain and share content, and users may access the Internet through terminal devices to enjoy various Internet services.

In addition, Internet platforms may also provide users with capabilities related to various types of information processing. How to improve the accuracy of such information processing has become a focus of attention.

### SUMMARY

In a first aspect of the present disclosure, a method for information processing is provided. The method includes: obtaining first information input by a target object for a first processing entity, where the first processing entity uniquely corresponds to the target object; and generating second information based on the first information and historical interaction information between the target object and the first processing entity, as a reply of the first processing entity to the first information.

In a second aspect of the present disclosure, a method for information processing is provided. The method includes: obtaining first information input by a target object for a first processing entity; and generating second information based on the first information and historical interaction information between the target object and the first processing entity, as a reply of the first processing entity to the first information, where the historical interaction information includes at least: first interaction information between the target object and the first processing entity in a first tool of a plurality of tools, and second interaction information between the target object and the first processing entity in a second tool of the plurality of tools.

In a third aspect of the present disclosure, a method for information processing is provided. The method includes: obtaining first information input by a target object for a first processing entity; processing the first information based on historical interaction information between the target object and the first processing entity, to generate third information; providing the third information for a second processing entity, where the second processing entity is different from the first processing entity; and generating second information based on a processing result of the second processing entity for the third information, as a reply of the first processing entity to the first information.

In a fourth aspect of the present disclosure, a method for message processing is provided. The method includes: obtaining at least one chat message between a target object and a first processing entity in a first component of an office suite; and presenting, in a second component of the office suite, a chat interface between the target object and the first processing entity, where the chat interface displays at least a portion of the at least one chat message.

In a fifth aspect of the present disclosure, an apparatus for information processing is provided. The apparatus includes: a first obtaining module configured to obtain first information input by a target object for a first processing entity, where the first processing entity uniquely corresponds to the target object; and a first generating module configured to generate second information based on the first information and historical interaction information between the target object and the first processing entity, as a reply of the first processing entity to the first information.

In a sixth aspect of the present disclosure, an apparatus for information processing is provided. The apparatus includes: a second obtaining module configured to obtain first information input by a target object for a first processing entity; and a second generating module configured to generate second information based on the first information and historical interaction information between the target object and the first processing entity, as a reply of the first processing entity to the first information, where the historical interaction information includes at least: first interaction information between the target object and the first processing entity in a first tool of a plurality of tools, and second interaction information between the target object and the first processing entity in a second tool of the plurality of tools.

In a seventh aspect of the present disclosure, an apparatus for information processing is provided. The apparatus includes: a third obtaining module configured to obtain first information input by a target object for a first processing entity; a processing module configured to process the first information based on historical interaction information between the target object and the first processing entity, to generate third information; a providing module configured to provide the third information for a second processing entity, where the second processing entity is different from the first processing entity; and a third generating module configured to generate second information based on a processing result of the second processing entity for the third information, as a reply of the first processing entity to the first information.

In an eighth aspect of the present disclosure, an apparatus for message processing is provided. The apparatus includes: a chat information obtaining module configured to obtain at least one chat message between a target object and a first processing entity in a first component of an office suite; and a chat interface presenting module configured to present, in a second component of the office suite, a chat interface between the target object and the first processing entity, where the chat interface displays at least a portion of the at least one chat message.

In a ninth aspect of the present disclosure, an electronic device is provided. The device includes at least one processing unit; and at least one memory coupled to the at least one processing unit and storing instructions executable by the at least one processing unit, where the instructions, when executed by the at least one processing unit, cause the device to perform the method according to the first aspect.

In a tenth aspect of the present disclosure, a computer-readable storage medium is provided. The computer-readable storage medium has a computer program stored thereon, where the computer program is executable by a processor to implement the method according to the first aspect.

It should be understood that the content described in this section is not intended to limit the key or important features of the embodiments of the present disclosure, nor is it intended to limit the scope of the present disclosure. Other features of the present disclosure will become readily comprehensible through the following description.

### BRIEF DESCRIPTION OF THE DRAWINGS

The above and other features, advantages, and aspects of the embodiments of the present disclosure will become more apparent when taken in conjunction with the drawings and with reference to the following detailed description. The same or similar reference numerals in the drawings represent the same or similar elements, where:

FIG. 1 shows a schematic diagram of an example environment in which embodiments of the present disclosure may be implemented;

FIG. 2 shows a flowchart of a method for information processing according to some embodiments of the present disclosure;

FIG. 3A and FIG. 3B show schematic diagrams of example interfaces of a digital assistant according to some embodiments of the present disclosure;

FIG. 4A and FIG. 4B show schematic diagrams of example interfaces of a digital assistant according to some further embodiments of the present disclosure;

FIG. 5 shows a flowchart of a method for information processing according to some embodiments of the present disclosure;

FIG. 6 shows a flowchart of a method for information processing according to some embodiments of the present disclosure;

FIG. 7 shows a flowchart of a method for message processing according to some embodiments of the present disclosure;

FIG. 8 shows a block diagram of an apparatus for information processing according to some embodiments of the present disclosure;

FIG. 9 shows a block diagram of an apparatus for information processing according to some embodiments of the present disclosure;

FIG. 10 shows a block diagram of an apparatus for information processing according to some embodiments of the present disclosure;

FIG. 11 shows a block diagram of an apparatus for message processing according to some embodiments of the present disclosure; and

FIG. 12 shows a block diagram of a device capable of implementing multiple embodiments of the present disclosure.

### DETAILED DESCRIPTION

It should be understood that, before using the technical solutions disclosed in the embodiments of the present disclosure, relevant users should be informed of the type, use range, use scenario, etc. of information involved in the present disclosure in an appropriate manner and authorization from the relevant users should be obtained, in accordance with relevant laws and regulations. The relevant users may include any type of right holder, such as an individual, an enterprise, or a group.

For example, when receiving an active request from a user, prompt information is sent to the relevant user to explicitly prompt the relevant user that the operation requested to be performed will require acquisition and use of information of the relevant user. In this way, the relevant user may choose whether to provide information to software or hardware such as an electronic device, an application, a server, or a storage medium that performs the operation of the technical solution of the present disclosure according to the prompt information.

As an optional but non-limiting implementation, a manner of sending the prompt information to the relevant user in response to receiving the active request from the relevant user may be, for example, a manner of a pop-up window, and the prompt information may be presented in the pop-up window in a text manner. In addition, the pop-up window may carry a selection control for the user to select “agree” or “disagree” to provide personal information to the electronic device.

It should be understood that the above process of notifying and obtaining user authorization is merely illustrative, and is not intended to limit implementations of the present disclosure. Other manners that satisfy relevant laws and regulations may also be applied to implementations of the present disclosure.

It should be understood that, when the technical solution is adopted, involved data (including but not limited to data itself, data acquisition, use, storage, and transmission) should comply with requirements of corresponding laws and regulations and relevant provisions.

As used herein, the term “in response to” represents a state in which a corresponding event occurs, or a condition is satisfied. It will be appreciated that an execution timing of a subsequent action performed in response to the event or condition is not necessarily strongly correlated with a time when the event occurs, or the condition is established. For example, in some cases, the subsequent action may be performed immediately when the event occurs or the condition is established; while in other cases, the subsequent action may be performed after a period of time since the event occurs or the condition is established.

Embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that titles of any section/sub-section provided herein are not limiting. Various embodiments are described throughout this document, and any type of embodiment may be included under any section/sub-section. In addition, embodiments described in any section/sub-section may be combined with any other embodiments described in the same section/sub-section and/or different section/sub-section in any manner.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. The terms “first” and “second” may refer to different or identical objects. Other explicit and implicit definitions may also be included below.

As used herein, the term “model” may learn an association between a corresponding input and output from training data, such that after the training is completed, a corresponding output may be generated for a given input. The generation and use of the model may be based on technologies allowed by laws and regulations such as machine learning, which may be referred to as available technologies for short. As an example, deep learning is a machine learning algorithm, which processes an input and provides a corresponding output by using a plurality of processing units. In this document, the “model” may also be referred to as a “machine learning model”, a “machine learning network” or a “network”, and these terms are used interchangeably herein. One model may further include different types of processing units or networks.

As briefly mentioned above, people may already use various types of information processing tools to improve the efficiency of information processing. For example, some digital assistants may generate corresponding responses according to dialog interactions (for example, texts or voices) with users.

However, this information processing process is usually a generalized capability, which provides similar information processing capabilities for many users. However, when different users have different interaction habits and requirements, it may be difficult for the users to obtain desired information processing results.

According to a first aspect of the present disclosure, an embodiment of the present disclosure provides a solution for information processing. Specifically, first information input by a target object (for example, a user or an organization, and the organization may be an enterprise, a group, a department, etc.) for a first processing entity may be obtained. The first processing entity may include, for example, a digital assistant (also referred to as a digital aide or a digital robot) of the target object, and may uniquely correspond to the target object. For example, the first processing entity may be specific to the target object.

Furthermore, second information may be generated based on the first information and historical interaction information between the target object and the first processing entity, as a reply of the first processing entity to the first information.

In this way, by providing the target object with the uniquely corresponding first processing entity and generating the reply with the historical interaction with the processing entity, embodiments of the present disclosure may provide different target objects with differentiated information processing processes, such that information processing results better satisfy the requirements of the target objects.

According to a second aspect of the present disclosure, an embodiment of the present disclosure provides a solution for information processing. Specifically, first information input by a target object (for example, a user or an organization, etc.) for a first processing entity may be obtained. The first processing entity may include, for example, a digital assistant (also referred to as a digital aide or a digital robot) of the target object. Furthermore, second information may be generated based on the first information and historical interaction information between the target object and the first processing entity, as a reply of the first processing entity to the first information.

Furthermore, the historical interaction information may include: first interaction information between the target object and the first processing entity in a first tool of a plurality of tools, and second interaction information between the target object and the first processing entity in a second tool of the plurality of tools.

In this way, embodiments of the present disclosure may generate a reply to the currently input information based on historical interaction information of the user in a plurality of tools, instead of relying only on current interaction information or interaction information in a current tool. In this way, embodiments of the present disclosure may make information processing results more in line with the expectations of the target object.

According to a third aspect of the present disclosure, an embodiment of the present disclosure provides a method for information processing. Specifically, first information input by a target object for a first processing entity may be obtained. The first information is processed based on historical interaction information between the target object and the first processing entity, to generate third information. The third information is provided for a second processing entity, and the second processing entity is different from the first processing entity. Second information is generated based on a processing result of the second processing entity for the third information, as a reply of the first processing entity to the first information.

In this way, embodiments of the present disclosure may generate, by the first processing entity, input information to the second processing entity based on the historical interaction information, such that the processing accuracy of the second processing entity in information processing may be improved, and the generated second information may better meet the requirements of the target object.

In a fourth aspect of the present disclosure, an embodiment of the present disclosure further provides a solution for message processing. Specifically, at least one chat message between a target object and a first processing entity in a first component of an office suite may be obtained. A chat interface between the target object and the first processing entity is presented in a second component of the office suite, where the chat interface displays at least a portion of the at least one chat message.

In this way, chat messages between the target object and the first processing entity in different office components may be presented in the same chat interface, such that the target object may be assisted to more clearly perceive and acquire historical interaction processes with the first processing entity in different components of the office suite, thereby facilitating the target object to improve interaction efficiency with the first processing entity.

Example embodiments of the present disclosure will be described below with reference to the drawings.

### Example Environment

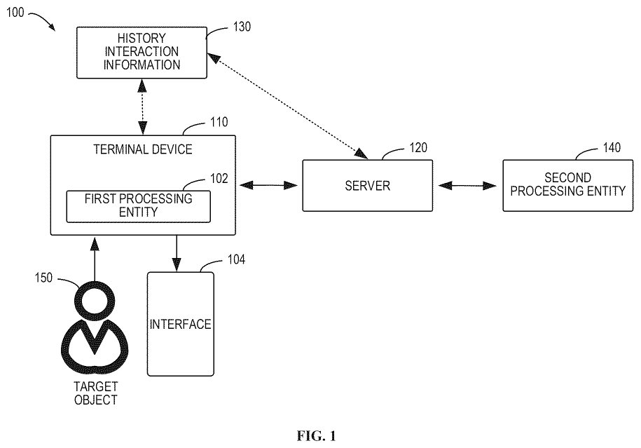

FIG. 1 shows a schematic diagram of an example environment 100 in which embodiments of the present disclosure may be implemented. As shown in FIG. 1, in the environment 100, a terminal device 110 may be used to provide a first processing entity 102 for a target object 150. As an example, the first processing entity 102 may include a digital assistant (also referred to as a digital aide or a digital robot). It should be understood that although the first processing entity 102 is shown to be included in the terminal device 110 in FIG. 1, some processing capabilities of the first processing entity 102 may also be based at least in part on a server 120. For example, a front-end part (for example, the part for presentation) of the first processing entity 102 may be included in the terminal device 110, but a back-end part (for example, the part for information processing) of the first processing entity 102 may be included in the server 120.

In some examples, the first processing entity 102 may be, for example, a digital assistant that assists the target object 150, e.g., in office tasks, or may be any other appropriate entity form. The first processing entity 102 may also operate independently or be integrated into a specific application.

In some embodiments, the first processing entity 102 may be enabled, for example, invoked or awakened, by an appropriate manner (for example, a shortcut key, a button, or voice). If the first processing entity 102 is in an active state, the terminal device 110 may present an interface 104 associated with the first processing entity 102. The interface 104 may be in the form of a conversational user interface (also referred to as a chat interface or a chat window), or may be in any other appropriate interface form. As will be described in detail below, the interface 104 may further include interface elements for information interaction, such as a message input box, a message list, a message bubble, etc. Through the interface 104, the first processing entity 102 may obtain information input by the target object 150 (also referred to as first information).

The input information may include, for example, any appropriate type of message, such as a text message, an image message, a voice message, a table message, a link message, other appropriate types of messages, etc. Furthermore, the server 120 may allow the target object 150 to interact with the first processing entity 102 to obtain information generated by the first processing entity 102. Alternatively, as will be described in detail below, the first processing entity 102 may also generate corresponding information based on information interaction between the first processing entity 102 and a second processing entity 140.

As an example, the first processing entity 102 obtains input information of the target object 150, and the first processing entity 102 or the server 120 may generate corresponding information (also referred to as third information) based on the input information and the historical interaction information 130. The historical interaction information 130 may indicate, for example, a historical interaction process between the target object 150 and the first processing entity 102. In the case where the target object 150 may interact with the first processing entity 102 in a plurality of tools (also referred to as components), the historical interaction information 130 may indicate historical interaction situations between the target object 150 and the first processing entity 102 in the plurality of tools.

Furthermore, the server 120 or the first processing entity 102 may send the generated third information to the second processing entity 140. Furthermore, the server 120 or the first processing entity 102 may generate corresponding information (also referred to as second information) based on information returned by the second processing entity 140 (that is, a processing result for the third information). For example, the second information may be presented to the target object 150 via the interface 104 corresponding to the first processing entity 102.

The second processing entity 140 may be a processing entity based on an appropriate information processing technology, and may implement one or more functions such as text generation, image generation, summarization, encoding, translation, chatbot, etc. The second processing entity 140 may also be any other appropriate entity form.

In addition, the historical interaction information 130 may include, for example, chat information between the target object 150 and the first processing entity 102. The chat information may be text, voice, image, or other forms of interaction between the target object 150 and the first processing entity 102 via the terminal device 110 and/or an attachment device of the terminal device 110.

In the case where the target object 150 is permitted, the historical interaction information 130 may further include interaction information between the target object 150 and other related components installed on the terminal device 110. Such components include but are not limited to office components, tool components, etc. The interaction information may be in the format of text, image, audio, video, or any other appropriate format. The terminal device 210 may store or synchronize the interaction information to the historical interaction information 130. In some embodiments, the historical interaction information 130 may be maintained at an appropriate electronic device (e.g., the terminal device 110, the server 120, and/or other appropriate electronic devices) as needed. The historical interaction information 130 may include, for example, both interaction information stored on the terminal device 110, and interaction information uploaded to the server 120.

In some embodiments, the terminal device 110 communicates with the server 120 to provide services related to the first processing entity 102. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination of the foregoing, including accessories and peripherals of these devices or any combination thereof. In some embodiments, the terminal device 110 may also support any type of interface (such as “wearable” circuit, etc.) for the target object 150. The server 120 may be various types of computing systems/servers capable of providing computing power, including but not limited to a mainframe, an edge computing node, a computing device in a cloud environment, etc.

Although only a server 120 is shown in FIG. 1, the environment 100 may include a plurality of servers 120. For example, the historical interaction information 130 may be stored locally or in a second server 120 as needed and with permission from the relevant user. The second processing entity 140 runs on a third server 120. It should be understood that this is only an example description and is not intended to imply any limitation on the scope of the present disclosure.

It should be understood that the structure and function of the environment 100 are described for illustrative purposes only, and are not intended to imply any limitation on the scope of the present disclosure. Some example embodiments of the present disclosure will be described below with reference to the drawings.

### First Example Information Processing Process

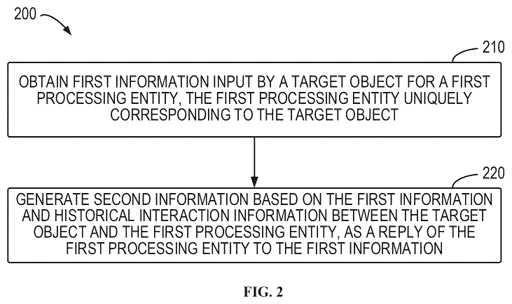

FIG. 2 shows a flowchart of a process 200 for information processing according to some embodiments of the present disclosure. The process 200 may be implemented by an appropriate electronic device or a combination of electronic devices (for example, the server 120, the terminal device 110, or a combination of the server 120 and the terminal device 110 in FIG. 1). For ease of description, the process 200 will be described below with the server 120 as an example and with reference to FIG. 1.

At block 210, the server 120 obtains first information input by a target object 150 for a first processing entity 102, where the first processing entity 102 uniquely corresponds to or is specific to the target object 150. In some embodiments, the target object 150 includes a user and/or an organization, for example, a user, a project group, a research group, a department, and so on. For example, the target object 150 may be associated with a user account or an organization account. As an example, the target object 150 may be configured with the uniquely corresponding first processing entity 102. For example, the first processing entity 102 may be provided as a digital assistant uniquely corresponding to the target object 150.

As an example, the digital assistant may be created as a contact specific to the target object 150. In some embodiments, the digital assistant being specific to the contact of the target object 150 includes that the digital assistant is only visible to the target object 150 and is not visible to other target objects.

The contact may also be configured with its corresponding virtual account, and the target object 150 may perform some operations similar to those for an ordinary contact on the contact. For example, the target object 150 may view the contact information of the contact.

Furthermore, for example, at least one attribute of the contact may be configured by the target object 150. For example, the target object 150 may configure a profile of its corresponding digital assistant. The content in the profile includes an avatar, a name, description information, etc. The target object may modify the information in the profile.

In other examples, the first processing entity 102 that uniquely corresponds to the target object 150 may also indicate that the first processing entity 102 is capable of providing information processing services specific to the target object 150. For example, in the case where different target objects 150 send the same input information to their respective corresponding first processing entities 102, different target objects 150 may obtain different responses.

In another example, the first processing entity 102 that uniquely corresponds to the target object 150 may also indicate that the first processing entity 102 has specific physical processing resources (for example, hardware devices) or virtual processing resources (for example, processing models) on the server 120.

As an example, the terminal device 110 may provide the first processing entity 102 that uniquely corresponds to the target object 150 only when there is the access, login or use of the target object 150.

It should be understood that “uniquely corresponding” may represent a one-to-one binding relationship between the first processing entity 102 and the target object 150. As an example, for different target objects 150, their respective corresponding first processing entities may also be different.

In another example, the target object 150 may include an aggregated object (for example, an organization, a team, etc.) composed of a plurality of users. The plurality of users may be provided with a corresponding single first processing entity 102 that uniquely corresponds to the aggregated object, respectively. In another example, the plurality of users in the aggregated object may not only be provided with one first processing entity 102 corresponding to the aggregated object, but also with a further first processing entity 102 that uniquely corresponds to the respective users.

It should be understood that “uniquely corresponding” in the present disclosure is not intended to limit that the first processing entity 102 will be updated accordingly based on the interaction process between the target object 150 and the first processing entity 102.

As will be described in detail below, in some embodiments, an information processing service specific to the target object 150 may be provided based on the historical interaction information 130 between the target object 150 and the first processing entity 102 and/or a data range specific to the target object 150. Therefore, the freedom of interaction between the target object 150 and the first processing entity 102 may be improved. For example, when a user interacts with a traditional information processing entity, the user usually needs to clearly and explicitly express the information processing requirements according to certain requirements. On the contrary, by considering the historical interaction information and/or the data range specific to the target object, embodiments of the present disclosure may support the user to express the information processing requirements in a more free and concise manner, without affecting the quality of the acquired information processing service.

In addition, this manner may also improve the information processing accuracy of the first processing entity 102. According to such an example implementation, the present disclosure may establish “unique correspondence” between the target object 150 and the first processing entity 102.

Furthermore, the target object 150 may input the first information to the first processing entity 102 by an appropriate manner. The first information may include, for example, a text message, a voice message, an image message, or other appropriate information types.

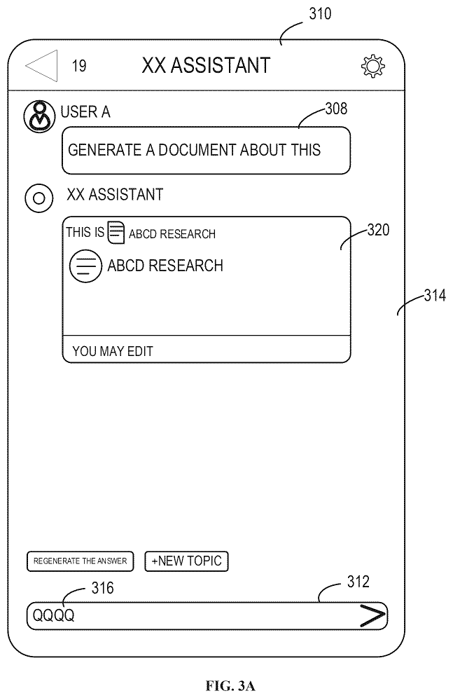

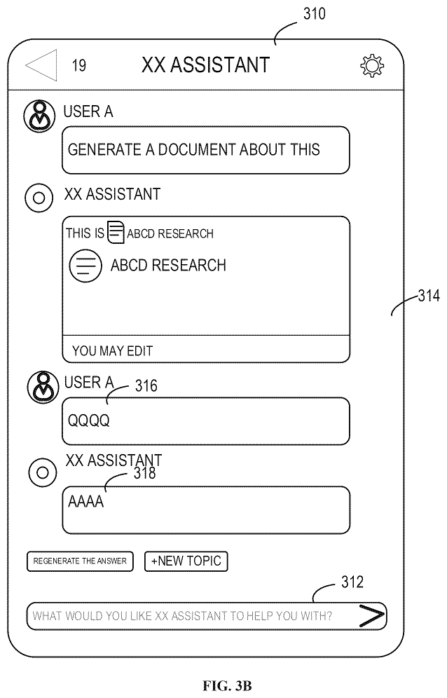

In some embodiments, for example, the target object 150 may interact with the first processing entity 102 through a graphical interface. Taking the digital assistant as the example of the first processing entity 102, FIG. 3A and FIG. 3B show schematic diagrams of example interfaces of the digital assistant according to some embodiments of the present disclosure. The examples in FIG. 3A and FIG. 3B may be implemented at the terminal device 110.

In the example of FIG. 3A, the first processing entity 102 that uniquely corresponds to the target object 150 (for example, user A) may include a digital assistant (for example, XX assistant). The terminal device 110 may provide an interface 310 corresponding to the digital assistant.

As shown in FIG. 3A, the interface 310 includes an information input control 312 and an information presenting area 314. The information presenting area 314 may be configured to display interaction records between the target object 150 and the first processing entity 102. For example, the information presenting area 314 may present historical interaction information 130 between “user A” and “XX assistant”, including a message 308 input by “user A” and a message 320 replied by “XX assistant”.

Furthermore, for example, the target object 150 may also input first information 316 to the first processing entity 102 with the input control 312. In some scenarios, the interaction process as shown in FIG. 3A may also be referred to as a dialog interaction process, i.e., the information input by the target object 150 is acquired in a manner similar to a dialog, and the first processing entity 102 correspondingly provides the reply. It should be understood that the interface 310 shown in FIG. 3A is only illustrative, and the first processing entity 102 may also be presented in some tools in other appropriate styles, which is not intended to be limited in the present disclosure.

Continuing to refer to FIG. 2, at block 220, the server 120 generates second information based on the first information and historical interaction information 130 between the target object 150 and the first processing entity 102, as a reply of the first processing entity 102 to the first information.

In some embodiments, the historical interaction information 130 may indicate the historical interaction between the target object 150 and the first processing entity 120. The historical interaction may include, for example, historical dialog messages between the target object 150 and the first processing entity 102, i.e., input message of the target object 150 and/or reply message of the first processing entity 102. Additionally, the historical interaction may further include feedback of the target object 150 regarding the reply message, such as whether the reply message is satisfactory, and whether a preset operation (for example, inserting the reply into a document, etc.) is performed based on the reply message.

Furthermore, in the process of generating the second information, the server 120 may consider not only the first information currently input by the target object 150 but also the historical interaction information 130, such that the generated second information may better meet the requirements of the target object 150.

In some embodiments, for example, the first processing entity 102 may be provided across a plurality of tools, which enables the target object 150 to initiate interaction with the first processing entity 102 in different tool scenarios.

Furthermore, the server 120 may determine the historical interaction information 130 based on historical interaction between the target object 150 and the first processing entity 102 in multiple tool scenarios.

In some embodiments, the server 120 may obtain first interaction information between the target object 150 and the first processing entity 102 in a first tool of a plurality of tools, and may obtain second interaction information between the target object 150 and the first processing entity 102 in a second tool of the plurality of tools. Furthermore, the server 120 may determine the historical interaction information 130 based at least on the first interaction information and the second interaction information.

As a specific example, for example, the target object 150 may interact with the first processing entity 102 in a document component, to query content associated with a specific subject or create a document associated with the specific subject. In addition, for example, the target object 150 may also interact with the first processing entity 102 in an email component, to generate an email associated with the specific subject.

In the case where the target object 150 authorizes the data range, the user may interact with the first processing entity 102 in a specific component (for example, a document component, an email component, a message component, etc.), and the input first information is related to the specific subject. Accordingly, when generating the second information, the server 120 may consider not only the input first information, but also historical interaction between the target object 150 and the first processing entity 102 regarding the specific subject in other components (for example, the email component and/or the document component).

In this way, embodiments of the present disclosure may enrich the context of information processing and make information processing more in line with the interaction habits of the user, thereby providing reply that better meets the requirements of the user.

In some embodiments, the plurality of tools includes a plurality of office components in an office suite. The office suite may be a set of office components developed to improve office efficiency, such as an office component for creating and editing a document, an office component for creating and editing a table, an office component for drawing, etc. In this way, global consistency across office components may be achieved, and richer and more accurate context information may be provided for information processing. Thus, in office scenarios, the target object 150 may be provided with more accurate information processing services that are in line with interaction habits.

In some embodiments, the plurality of office components includes multiple of the following: a chat component, a document component, an audio-video conferencing component, an email component, a calendar component, a schedule component, a task component, an objectives and key results (OKR) component, and/or other appropriate office components currently available or that may be developed in the future.

In this way, by considering interaction behaviors with the first processing entity 102 (for example, a digital assistant) in the plurality of office components, embodiments of the present disclosure may achieve information collaboration among a plurality of components, thereby providing more accurate information processing capabilities.

In some embodiments, interaction information between the target object 150 and the first processing entity 102 in the plurality of tools may be stored in association with the target object. For example, with the user's permission, the user's interaction information in different tools may be maintained in association with the user, for example, maintained locally on the terminal or on the server 120 or other devices. Alternatively, the user's interaction information in different tools may be stored in association with the user by using a unified storage identification or a unified storage manner.

In addition, by managing the interaction information with global consistency, embodiments of the present disclosure may maintain the uniquely corresponding historical interaction information 130 for the target object 150, such that the reply generated by the first processing entity 102 may consider the interaction habit or historical interaction content of the target object 150.

In some embodiments, as discussed with reference to FIG. 1, the server 120 may also generate information with the second processing entity 140.

Specifically, the server 120 may process the first information based on the historical interaction information 130 to generate third information. Furthermore, the server 120 may provide the third information for the second processing entity 140, where the second processing entity 140 is different from the first processing entity 102. Additionally, the server 120 may generate the second information based on a processing result of the second processing entity 140 for the third information.

In some embodiments, the second processing entity 140 may include a target model, for example, a target language model. Correspondingly, for example, the third information may include input information to the target model. In some scenarios, the third information may also be referred to as a prompt word, a guide word, or a prompt, etc. of the target model. It should be understood that, for example, depending on the needs of actual scenarios, the second processing entity 140 may further include other appropriate models.

In order to obtain more accurate and effective third information, the server 120 may process the first information based on the historical interaction information 130. In some embodiments, the server 120 may determine, from the historical interaction information 130, a group of associated historical interaction information 130 associated with the first information.

It should be understood that the group of associated historical interaction information 130 associated with the first information may be determined with any appropriate technology. As an example, the server 120 may perform semantic analysis on the first information, and determine the group of associated historical interaction information 130 associated with the semantics of the first information from the historical interaction information 130. Alternatively, for example, the server 120 may determine, from the historical interaction information 130, the group of associated historical interaction information 130 that is semantically associated with the first information based on keyword search or matching. The present disclosure is not intended to limit the specific determination process of the group of associated historical interaction information 130.

Correspondingly, the server 120 may also generate the third information based on the first information and the group of associated historical interaction information 130. For example, the server 120 may generate the third information by adding additional information corresponding to the group of associated historical interaction information 130 while retaining the first information.

As an example, the additional information may be generated, for example, based on the group of associated historical interaction information 130.

As another example, the server 120 may also rewrite the first information based on the group of historical interaction information 130. For example, the server 120 may expand the first information, such that the first information may more accurately reflect the requirements of the target object 150.

In this way, based on the historical interaction information 130, embodiments of the present disclosure may generate third information that is more in line with the interaction requirements of the target object 150, and may improve the accuracy of information processing while the user maintains his/her personal interaction habit.

In some embodiments, the server 120 may generate the third information further base on policy information corresponding to the first information. The policy information may indicate, for example, at least a policy for instructing the second processing entity 140 to process the first information.

Considering that the second processing entity 140 may be a general model, it may not be able to determine an information processing policy in a specific field or a specific scenario. By reflecting the policy information in the third information input to the second processing entity 140, the second processing entity 140 may be assisted to perform information processing according to the preset policy, such that the generated result may better satisfy the expectation.

Furthermore, the server 120 may also generate the second information based on the processing result of the second processing entity 140 for the third information. As an example, the server 120 may directly use the processing result as the generated second information. As another example, the server 120 may appropriately process the processing result to generate the second information. As yet another example, the processing result of the second processing entity 140 may indicate, for example, a subsequent action that needs to be performed by the server 120. The server 120 may perform a corresponding subsequent action and further generate the second information based on an execution result of the subsequent action.

In some embodiments, the second information may also be generated based on a target data range corresponding to the target object 150. The target data range may include, for example, a range of data that the first processing entity 120 is permitted to access or use. Furthermore, the server 120 may generate the second information based on the historical interaction information 130, the input first information, and the target data range.

In some embodiments, the target data range may be based on a first data range corresponding to the permission of the target object 150. As an example, the first data range may include data in an office suite to which the user has specific access permissions (for example, administrative permission, editing permission, reading permissions, etc.). Therefore, in the process of generating the second information for the first information, the server 120 and/or the first processing entity 102 will not be permitted to access data content outside the first data range.

In some embodiments, the target data range may also be determined based on a second data range corresponding to configuration information of the target object 150. The configuration information at least indicates a data range that the target object 150 permits the first processing entity 102 to access. For example, in the scenario where the first processing entity 102 is a digital assistant, the user may configure the data range that the digital assistant is permitted to access in the interaction process.

It should be understood that the above process of determining the data range may be known to one or more users associated with the data, and is determined based on explicit permission and/or configuration information of the one or more users. In addition, the process of determining the corresponding data range and the data processing process should be performed in compliance with laws and regulations of the region where the user is located.

In this way, in the process of information processing, embodiments of the present disclosure may consider not only the historical interaction information 130 between the target object 150 and the first processing entity 102, but also the data range specific to the target object 150. In this way, embodiments of the present disclosure may provide an information processing service specific to the target object 150 based on the historical interaction information 130 and the specific data range, thereby improving the freedom of interaction between the target object 150 and the first processing entity 102, and improving the information processing accuracy of the first processing entity 102.

Furthermore, reference may be made to FIG. 3B. The terminal device 110 may obtain the second information 318 generated based on the first information 316, and provide the second information 318 in the interface 310, as a reply to the first information 316.

The above discusses an example process in which the first processing entity 102 generates the second information based on the first information input by the target object 150. Based on the above manner, embodiments of the present disclosure may improve the accuracy of information processing, such that the generated second information is more in line with the interaction habits of the target object 150 and its requirements for the interaction result.

In some embodiments, as discussed above, the first processing entity 102 may be provided as a digital assistant of the target object 150 (for example, a user or an organization). In some embodiments, for example, the digital assistant may be provided as a target contact of the user or the organization in a chat tool.

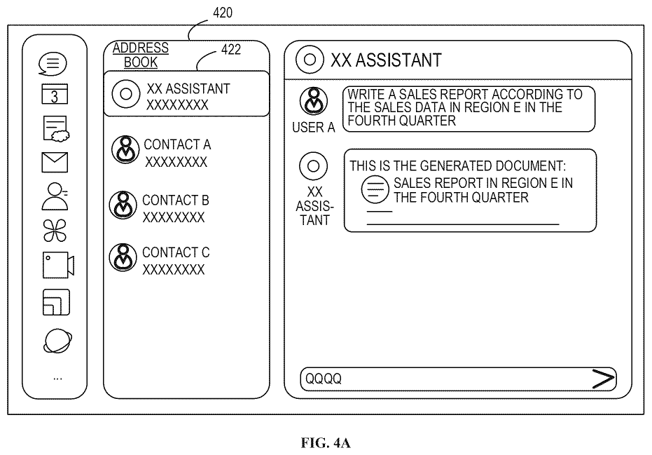

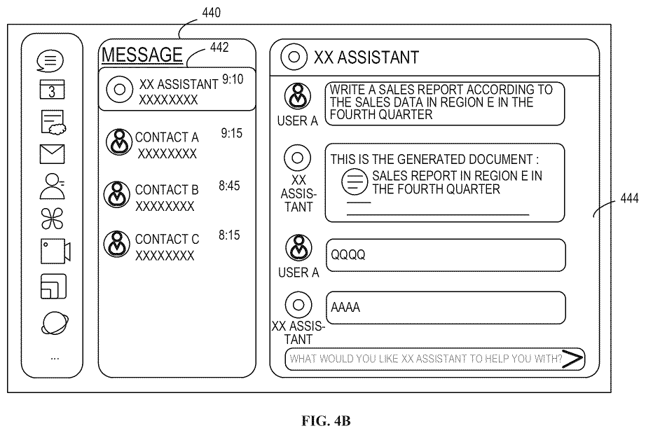

FIG. 4A shows an example interface according to some embodiments of the present disclosure. As shown in FIG. 4, a digital assistant (for example, XX assistant) may be provided as a target contact 422 of the user or the organization in the chat tool as shown in FIG. 4A. For example, the chat tool may include a chat component in an office suite, or may include an independent chat application (for example, an instant messaging application).

In some embodiments, as shown in FIG. 4A, the target contact 422 may also be presented in a contact list 420 corresponding to the user or the organization. As an example, the target contact 422 may be presented at a predetermined position in the contact list 420. For example, the target contact 422 may always be displayed at the top, or fixed at another appropriate display position.

In some embodiments, the second information generated by the first processing entity 102 may also be provided in a chat interface corresponding to the target contact. For example, FIG. 4B shows a chat interface corresponding to the target contact. For example, the interface may be presented by a predetermined operation (for example, double-click) on the target contact 422.

As shown in FIG. 4B, the chat interface may be provided in an information presenting area 444 of the chat interface, as a reply to the input first information.

In some embodiments, the target chat corresponding to the chat interface is fixedly presented at the predetermined position in the chat list of the user or the organization. For example, the terminal device 110 may also provide a chat list 440, and the chat with the digital assistant (for example, XX assistant) may be displayed at the predetermined position in the chat list 440. For example, the chat may always be displayed at the top, or fixed at another appropriate display position.

In some embodiments, the chat interface is further configured to present interaction information between the user or the organization and the digital assistant in at least one further office component. As an example, the user or the organization may also interact with the digital assistant in further office components such as an email component, a conferencing component, or a document component.

Furthermore, the interaction information with other office components may also be presented (also referred to as write-back) in the chat interface with the digital assistant, such that the user or the organization may perceive their global interactions with the digital assistant in the office suite.

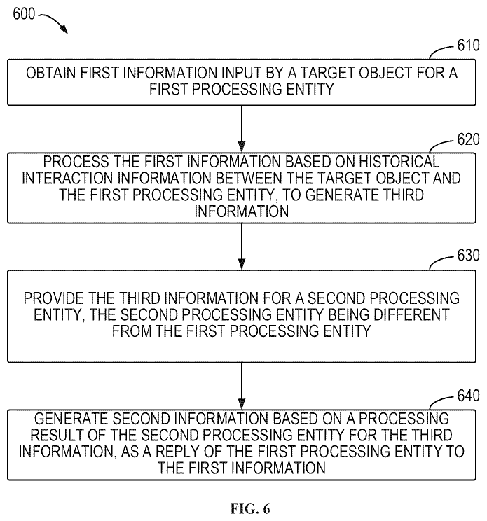

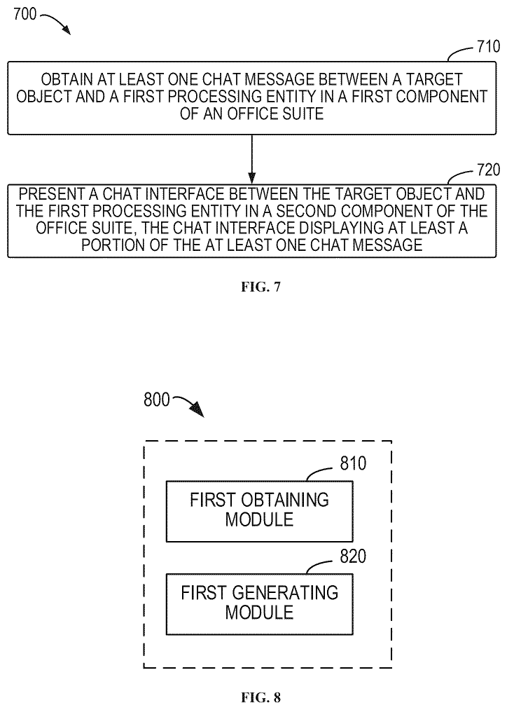

The presentation manner of the interaction information will be described below with reference to FIG. 7, and will not be described in detail here.

It should be understood that without departing from the gist of the first example information processing process, one or more steps, features, characteristics, or combinations thereof described below with reference to other example processes may also be appropriately combined into the first example information processing process. This will not be repeated in the present disclosure.

### Second Example Information Processing Process

FIG. 5 shows a flowchart of a process 500 for information processing according to some embodiments of the present disclosure. The process 500 may be implemented by an appropriate electronic device or a combination of electronic devices (for example, the server 120, the terminal device 110, or a combination of the server 120 and the terminal device 110 in FIG. 1). For ease of description, the process 500 will be described below with the server 120 as an example and with reference to FIG. 1.

At block 510, the server 120 obtains first information input by a target object 150 for a first processing entity 102.

For the process of obtaining the first information, reference may be made to the content described above in conjunction with block 210. Details will not be described here again. It should be understood that, for example, in this example process, the first processing entity 102 may uniquely correspond to the target object 150. Alternatively, for example, the first processing entity 102 may include a unified processing entity for providing general processing capabilities.

At block 520, the server 120 generates second information based on the first information and historical interaction information 130 between the target object 150 and the first processing entity 102, as a reply of the first processing entity 102 to the first information. Furthermore, the historical interaction information 130 includes at least: first interaction information between the target object 150 and the first processing entity 102 in a first tool of a plurality of tools, and second interaction information between the target object 150 and the first processing entity 102 in a second tool of the plurality of tools.

As discussed above, in some embodiments, for example, the first processing entity 102 may be provided across a plurality of tools, which enables the target object 150 to initiate interaction with the first processing entity 102 in different tool scenarios.

Furthermore, the server 120 may determine the historical interaction information 130 based on historical interaction between the target object 150 and the first processing entity 102 in a plurality of tool scenarios.

In some embodiments, the server 120 may obtain first interaction information between the target object 150 and the first processing entity 102 in a first tool of a plurality of tools, and may obtain second interaction information between the target object 150 and the first processing entity 102 in a second tool of the plurality of tools. Furthermore, the server 120 may determine the historical interaction information 130 based at least on the first interaction information and the second interaction information.

As a specific example, the target object 150 may interact with the first processing entity 102 in a document component, for example, to query content associated with a specific subject or create a document associated with the specific subject. In addition, the target object 150 may also interact with the first processing entity 102 in an email component, for example, to generate an email associated with the specific subject.

In the case where the target object 150 permits the data range, the user may interact with the first processing entity 102 in a specific component (for example, a document component, an email component, a message component, etc.), and the input first information is related to the specific subject. Accordingly, when generating the second information, the server 120 may consider not only the input first information, but also historical interaction between the target object 150 and the first processing entity 102 regarding the specific subject in other components (for example, the email component and/or the document component).

In this way, embodiments of the present disclosure may enrich the context of information processing and make information processing more in line with the historical interaction habits of the user, thereby providing reply that better meets the requirements of the user.

In some embodiments, the plurality of tools includes a plurality of office components in an office suite. The office suite may be a set of office components developed to improve office efficiency, such as an office component for creating and editing a document, an office component for creating and editing a table, an office component for drawing, etc. In this way, global consistency across office components may be achieved, and richer and more accurate context information may be provided for information processing. Thus, in office scenarios, the target object 150 may be provided with more accurate information processing services that are in line with interaction habits.

In some embodiments, the plurality of office components includes multiple of the following: a chat component, a document component, an audio-video conferencing component, an email component, a calendar component, a schedule component, a task component, an objectives and key results (OKR) component, and/or other appropriate office components currently available or that may be developed in the future.

In this way, by considering interaction behaviors with the first processing entity 102 (for example, a digital assistant) in the plurality of office components, embodiments of the present disclosure may achieve information collaboration among a plurality of components, thereby providing more accurate information processing services.

In some embodiments, interaction information between the target object 150 and the first processing entity 102 in the plurality of tools may be stored in association with the target object 150. For example, with the user's permission, the user's interaction information in different tools may be maintained in association with the user, for example, maintained locally on the terminal or on the server 120 or other devices.

In addition, by managing the interaction information with global consistency, embodiments of the present disclosure may maintain the uniquely corresponding historical interaction information 130 for the target object 150, such that the reply generated by the first processing entity 102 may consider the interaction habit or historical interaction content of the target object 150.

It should be understood that without departing from the gist of the second example information processing process, one or more steps, features, characteristics, or combinations thereof described with reference to other example information processing processes may also be appropriately combined into the second example information processing process. This will not be repeated in the present disclosure.

### Third Example Information Processing Process

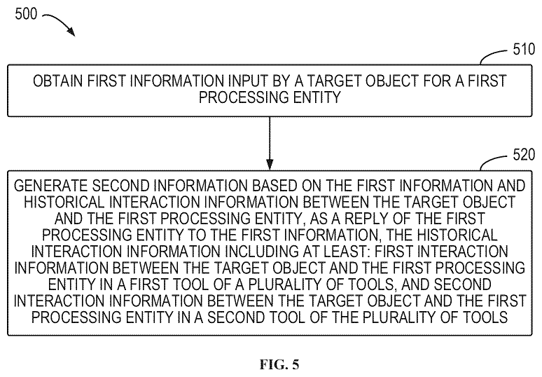

FIG. 6 shows a flowchart of a process 600 for information processing according to some embodiments of the present disclosure. The process 600 may be implemented by an appropriate electronic device or a combination of electronic devices (for example, the server 120, the terminal device 110, or a combination of the server 120 and the terminal device 110 in FIG. 1). For ease of description, the process 600 will be described below with the server 120 as an example and with reference to FIG. 1.

At block 610, the server 120 obtains first information input by a target object 150 for a first processing entity 102.

For the process of obtaining the first information, reference may be made to the content described above in conjunction with block 210. Details will not be described here again. It should be understood that, for example, in this example process, the first processing entity 102 may uniquely correspond to the target object 150. Alternatively, for example, the first processing entity 102 may include a unified processing entity for providing general processing capabilities.

At block 620, the server 120 processes the first information based on historical interaction information 130 between the target object 150 and the first processing entity 102, to generate third information.

In some embodiments, the second processing entity 140 may include a target model, such as a target language model. Correspondingly, for example, the third information may include input information to the target model. In some scenarios, the third information may also be referred to as a prompt word, a guide word, or a prompt, etc. of the target model. It should be understood that, for example, depending on the needs of actual scenarios, the second processing entity 140 may further include other appropriate models.

In order to obtain more accurate and effective third information, the server 120 may process the first information based on the historical interaction information 130. In some embodiments, the server 120 may determine, from the historical interaction information 130, a group of associated historical interaction information 130 associated with the first information.

It should be understood that the group of associated historical interaction information 130 associated with the first information may be determined with any appropriate technology. As an example, the server 120 may perform semantic analysis on the first information, and determine the group of associated historical interaction information 130 associated with the semantics of the first information from the historical interaction information 130. Alternatively, for example, the server 120 may determine, from the historical interaction information 130, the group of associated historical interaction information 130 that is semantically associated with the first information based on keyword search or matching. The present disclosure is not intended to limit the specific determination process of the group of associated historical interaction information 130.

Correspondingly, the server 120 may also generate the third information based on the first information and the group of associated historical interaction information 130. For example, the server 120 may generate the third information by adding additional information corresponding to the group of associated historical interaction information 130 while retaining the first information.

As an example, such additional information may be generated based on the group of associated historical interaction information 130, for example.

As another example, the server 120 may also rewrite the first information based on the group of historical interaction information 130. For example, the server 120 may expand the first information, such that the first information may more accurately reflect the requirements of the target object 150.

In this way, based on the historical interaction information 130, embodiments of the present disclosure may generate third information that is more in line with the interaction requirements of the target object 150, and may improve the accuracy of information processing while the user maintains his/her personal interaction habit.

In some embodiments, the server 120 may generate the third information further base on policy information corresponding to the first information. The policy information may indicate, for example, at least a policy for instructing the second processing entity 140 to process the first information.

Considering that the second processing entity 140 may be a general model, it may not be able to determine an information processing policy in a specific field or a specific scenario. By reflecting the policy information in the third information input to the second processing entity 140, the second processing entity 140 may be assisted to perform information processing according to the preset policy, such that the generated result may better satisfy the expectation.

At block 630, the server 120 provides the third information for the second processing entity 140, where the second processing entity 140 is different from the first processing entity 102. At block 640, the server 120 generates the second information based on a processing result of the second processing entity 140 for the third information, as a reply of the first processing entity 102 to the first information.

As an example, the server 120 may also provide the third information for the second processing entity 140, and may generate the second information based on the processing result of the second processing entity 140 for the third information. As an example, the server 120 may directly use the processing result as the generated second information. As another example, the server 120 may appropriately process the processing result to generate the second information. As yet another example, the processing result of the second processing entity 140 may indicate, for example, a subsequent action that needs to be performed by the server 120. The server 120 may perform a corresponding subsequent action and further generate the second information based on an execution result of the subsequent action.

Based on the process discussed above, embodiments of the present disclosure may improve the accuracy of information processing by optimizing the input information to the second processing entity 140.

It should be understood that without departing from the gist of the third example information processing process, one or more steps, features, characteristics, or combinations thereof described with reference to other example information processing processes may also be appropriately combined into the third example information processing process. This will not be repeated in the present disclosure.

### Fourth Example Message Processing Process

FIG. 7 shows a flowchart of a process 700 for message processing according to some embodiments of the present disclosure. The process 700 may be implemented by an appropriate electronic device or a combination of electronic devices (for example, the server 120, the terminal device 110, or a combination of the server 120 and the terminal device 110 in FIG. 1). The process 700 will be described below by taking the terminal device 110 as an example.

At block 710, the terminal device 110 obtains at least one chat message between the target object 150 and the first processing entity 102 in a first component of an office suite.

As discussed above, the office suite may include a plurality of components (also referred to as office components), examples of which may include but are not limited to: a chat component, a document component, an audio-video conferencing component, an email component, a calendar component, a schedule component, a task component, an objectives and key results (OKR) component, and/or other appropriate office components currently available or that may be developed in the future.

Furthermore, the terminal device 110 may obtain at least one chat message between the target object 150 and the first processing entity 102 in a specific component. For example, the target object 150 may interact with the digital assistant in the document component of the office suite, and at least one chat message may be generated.

At block 720, the terminal device 110 presents, in a second component of the office suite, a chat interface between the target object 150 and the first processing entity 102. The chat interface displays at least a portion of the at least one chat message.

As an example, the second component includes, for example, a further component in the office suite that is different from the first component. For example, the target object 150 may also interact with the digital assistant in the email component, and a chat interface is presented accordingly.

Accordingly, for example, the terminal device 110 may also present, in the chat interface of the second component (for example, the email component), a portion of the at least one chat message in the first component (for example, the document component).

As yet another example, the second component may be, e.g., a chat component. As an example, merely in the chat interface of the chat component, the terminal device 110 may present a portion of the at least one chat message of the other components. In other office components (for example, the email component), the terminal device 110 may only present the historical interaction information 130 in the office component.

By providing the portion of the at least one chat message of the other components in the chat interface of the chat component, embodiments of the present disclosure may provide the user with a unified global message, thereby facilitating the user to perceive or query the historical interaction behavior with the digital assistant.

In some embodiments, the terminal device 110 may display an aggregated message corresponding to the at least one chat message in the chat interface. For example, in the case where the target object 150 has a plurality of rounds of chats with the digital assistant in the document component, the terminal device 110 may present the aggregated message corresponding to the plurality of rounds of chats in the chat interface, thereby improving the efficiency of information display in the interface and reducing interference with the current interaction of the user.

In some embodiments, the terminal device 110 may receive a selection of the aggregated message and present the entire content of the at least one chat message accordingly. For example, the entire content of the chat message may be presented within the current screen display range, or the entire content of the chat may be presented by adjusting the current screen display range through scrolling the mouse, etc. In this way, in the case where the user expects to view the chat messages with the digital assistant in other components, embodiments of the present disclosure may provide the user with complete chat messages.

In some embodiments, the server 120 receives the selection of the aggregated message, and the terminal device 110 presents the entire content of the at least one chat message. The presentation manner includes but is not limited to presenting the full text of each chat message or only presenting the preceding part of each chat message, etc. For example, when the user selects the aggregated message, a plurality of chat messages included therein may be expanded in turn or only the first chat message is expanded. When the user further selects another chat message, the chat message is presented accordingly, and the expanded chat message is collapsed.

In some embodiments, in the chat interface, at least a portion of the at least one chat message is presented in a card style. For example, the terminal device 110 may provide, e.g., a card corresponding to the at least one chat message. The card may be interactive as a whole card. For example, the card may be forwarded, deleted, moved, copied to other positions, etc. as a whole.

In some embodiments, for example, the server 120 may obtain the corresponding at least one chat message in a granularity of historical interaction events. For example, the server 120 may obtain at least one chat message corresponding to a historical interaction event between the target object 150 and the first processing entity 102 in the first component.

In some embodiments, the historical interaction event includes at least one round of dialog interaction between the target object 150 and the first processing entity 102. For example, it may be determined whether the plurality of rounds of dialog interaction belongs to the same historical interaction event based on an interval time between the at least one round of dialog interaction. As an example, two rounds of dialog interaction with an interval time exceeding a threshold time may be determined as not belonging to the same historical interaction event.

In this way, embodiments of the present disclosure may determine the corresponding historical interaction event according to the aggregation of the dialog interaction, and may correspondingly present, in the chat interface with the digital assistant, at least one chat message corresponding to the historical interaction event. In some embodiments, the historical chat message corresponding to at least one round of dialog interaction in a single historical interaction event is presented as an aggregated message in the chat interface. For example, different rounds of dialog interaction corresponding to different historical interaction events may be presented as different aggregated messages in the chat interface.

The aggregated message may adopt the form of a topic message or other possible message string forms, which is not limited here.

Based on the process discussed above, embodiments of the present disclosure may enable the user or the organization to perceive the global interaction process with the digital assistant in the office suite, thereby improving the interaction experience of the user. In addition, this may also help to perceive that the generation process of the second information discussed above is based on the global interaction process between the user or the organization and the office suite.

It should be understood that without departing from the gist of the fourth example message processing process, one or more steps, features, characteristics, or combinations thereof described with reference to the above example information processing processes may also be appropriately combined into the fourth example message processing process. This will not be repeated in the present disclosure.

### Example Apparatus and Device

FIG. 8 shows a schematic block diagram of an apparatus 800 for information processing according to some embodiments of the present disclosure. The apparatus 800 may be implemented as or included in the server 120, the terminal device 110, or a combination of the server 120 and the terminal device 110 in FIG. 1. Various modules/components in the apparatus 800 may be implemented by hardware, software, firmware, or any combination thereof.

As shown in the figure, the apparatus 800 includes a first obtaining module 810. The first obtaining module 810 is configured to obtain first information input by a target object for a first processing entity. The first processing entity uniquely corresponds to the target object. The apparatus 800 further includes a first generating module 820. The first generating module 820 is configured to generate second information based on the first information and historical interaction information between the target object and the first processing entity, as a reply of the first processing entity to the first information.

In some embodiments, the apparatus 800 further includes a first interaction information obtaining module configured to obtain first interaction information between the target object and the first processing entity in a first tool of a plurality of tools; a second interaction information obtaining module configured to obtain second interaction information between the target object and the first processing entity in a second tool of the plurality of tools; and an interaction information determining module configured to determine the historical interaction information based at least on the first interaction information and the second interaction information.

In some embodiments, the plurality of tools includes a plurality of components in an office suite.

In some embodiments, interaction information between the target object and the first processing entity in the plurality of tools is stored in association with the target object.

In some embodiments, the first generating module 820 is configured to process the first information based on the historical interaction information, to generate third information; provide the third information for a second processing entity, where the second processing entity is different from the first processing entity; and generate the second information based on a processing result of the second processing entity for the third information.

In some embodiments, the third information includes guidance information, and the second processing entity includes a target model.

In some embodiments, the first generating module 820 is further configured to determine, from the historical interaction information, a group of associated historical interaction information associated with the first information; and generate the third information based on the first information and the group of associated historical interaction information.

In some embodiments, the third information is generated further based on policy information corresponding to the first information. The policy information at least indicates a policy for instructing the second processing entity to process the first information.

In some embodiments, the first generating module 820 is configured to determine a target data range corresponding to the target object; and generate the second information based on the historical interaction information, the first information, and the target data range.

In some embodiments, the target data range is determined based at least on a first data range corresponding to the permission of the target object.

In some embodiments, the target data range is determined based at least on a second data range corresponding to configuration information of the target object. The configuration information at least indicates a data range that the target object permits the first processing entity to access.

In some embodiments, the target object includes a user or an organization, and the first processing entity is provided as a digital assistant corresponding to the user or the organization.

In some embodiments, the digital assistant is provided as a target contact of the user or the organization in a chat tool.

In some embodiments, the target contact is presented in the contact list corresponding to the user or the organization.

In some embodiments, the target contact is presented at the predetermined position in the contact list.

In some embodiments, the apparatus 800 further includes a providing module, configured to cause the second information to be provided in the chat interface corresponding to the target contact.

In some embodiments, a target chat corresponding to the chat interface is fixedly presented at the predetermined position in a chat list of the user or the organization.

In some embodiments, the chat interface is further configured to present interaction information between the user or the organization and the digital assistant in at least one further office component.

FIG. 9 shows a schematic structural block diagram of an apparatus 900 for information processing according to some embodiments of the present disclosure. The apparatus 900 may be implemented as or included in the server 120, the terminal device 110, or a combination of the server 120 and the terminal device 110 in FIG. 1. Various modules/components in the apparatus 900 may be implemented by hardware, software, firmware, or any combination thereof.

As shown in the figure, the apparatus 900 includes a second obtaining module 910. The second obtaining module 910 is configured to obtain first information input by a target object for a first processing entity. The apparatus 900 further includes a second generating module 920. The second generating module 920 is configured to generate second information based on the first information and historical interaction information between the target object and the first processing entity, as a reply of the first processing entity to the first information. The historical interaction information includes at least: first interaction information between the target object and the first processing entity in a first tool of a plurality of tools, and second interaction information between the target object and the first processing entity in a second tool of the plurality of tools.

In some embodiments, the plurality of tools includes a plurality of components in an office suite.

In some embodiments, interaction information between the target object and the first processing entity in the plurality of tools is stored in association with the target object.

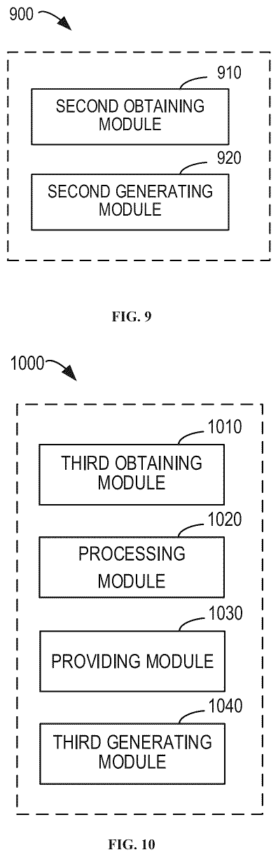

FIG. 10 shows a schematic structural block diagram of an apparatus 1000 for information processing according to some embodiments of the present disclosure. The apparatus 1000 may be implemented as or included in the server 120, the terminal device 110, or a combination of the server 120 and the terminal device 110 in FIG. 1. Various modules/components in the apparatus 1000 may be implemented by hardware, software, firmware, or any combination thereof.

As shown in the figure, the apparatus 1000 includes a third obtaining module 1010. The third obtaining module 1010 is configured to obtain first information input by a target object for a first processing entity. The apparatus 1000 further includes a processing module 1020. The processing module 1020 is configured to process the first information based on historical interaction information between the target object and the first processing entity, to generate third information. The apparatus 1000 further includes a providing module 1030. The providing module 1030 is configured to provide the third information for a second processing entity, where the second processing entity is different from the first processing entity. The apparatus 1000 further includes a third generating module 1040. The third generating module 1040 is configured to generate second information based on a processing result of the second processing entity for the third information, as a reply of the first processing entity to the first information.

In some embodiments, the third information includes guidance information, and the second processing entity includes a target model.

In some embodiments, the processing module 1020 is configured to determine, from the historical interaction information, a group of associated historical interaction information associated with the first information; and generate the third information based on the first information and the group of associated historical interaction information.

In some embodiments, the third information is generated further based on policy information corresponding to the first information, where the policy information at least indicates a policy for instructing the second processing entity to process the first information.

In some embodiments, the apparatus 1000 further includes a first interaction information obtaining module configured to obtain first interaction information between the target object and the first processing entity in a first tool of a plurality of tools; a second interaction information obtaining module configured to obtain second interaction information between the target object and the first processing entity in a second tool of the plurality of tools; and an interaction information determining module configured to determine the historical interaction information based at least on the first interaction information and the second interaction information.

In some embodiments, the plurality of tools includes a plurality of components in an office suite.

In some embodiments, interaction information between the target object and the first processing entity in the plurality of tools is stored in association with the target object.

FIG. 11 shows a schematic structural block diagram of an apparatus 1100 for message processing according to some embodiments of the present disclosure. The apparatus 1100 may be implemented as or included in the server 120, the terminal device 110, or a combination of the server 120 and the terminal device 110 in FIG. 1. Various modules/components in the apparatus 1100 may be implemented by hardware, software, firmware, or any combination thereof.

As shown in the figure, the apparatus 1100 includes a chat information obtaining module 1110. The chat information obtaining module 1110 is configured to obtain at least one chat message between the target object and the first processing entity in a first component of an office suite. The apparatus 1100 further includes a chat interface presenting module 1120. The chat interface presenting module 1120 is configured to present, in a second component of the office suite, a chat interface between the target object and the first processing entity. The chat interface displays at least a portion of the at least one chat message.

In some embodiments, the second component includes a chat component in the office suite.

In some embodiments, the chat interface displays an aggregated message corresponding to the at least one chat message.

In some embodiments, the apparatus 1100 further includes a receiving module configured to receive a selection of the aggregated message; and a presenting module configured to present the entire content of the at least one chat message.

In some embodiments, in the chat interface, at least a portion of the at least one chat message is presented in a card style.

In some embodiments, the chat information obtaining module 1110 is configured to obtain at least one chat message corresponding to a historical interaction event between the target object and the first processing entity in the first component.

In some embodiments, the historical interaction event includes at least one round of dialog interaction between the target object and the first processing entity.

In some embodiments, the historical chat message corresponding to the at least one round of dialog interaction is presented as the aggregated message in the chat interface.

In some embodiments, the target object includes a user and/or an organization, and the first processing entity is provided as a digital assistant corresponding to the user or the organization.

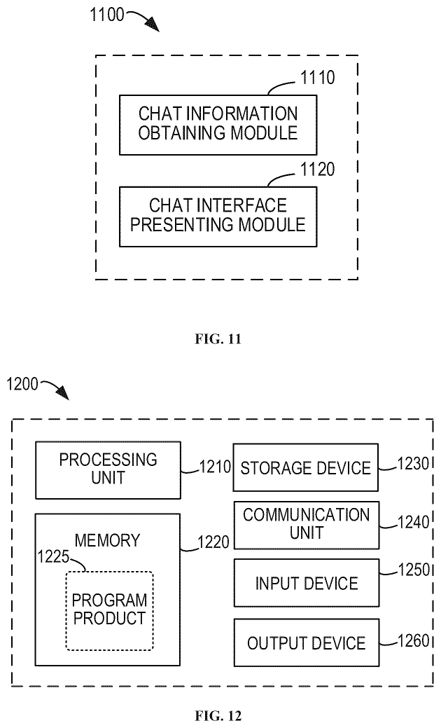

FIG. 12 shows a block diagram of an electronic device 1200 in which one or more embodiments of the present disclosure may be implemented. It should be understood that the electronic device 1200 shown in FIG. 12 is only exemplary and should not constitute any limitation on the function and scope of the embodiments described herein. The electronic device 1200 shown in FIG. 12 may be used to implement the server 120, the terminal device 110, or a combination of the server 120 and the terminal device 110 in FIG. 1.

As shown in FIG. 12, the electronic device 1200 is in the form of a general-purpose electronic device. The components of the electronic device 1200 may include, but are not limited to, one or more processors or processing units 1210, a memory 1220, a storage device 1230, one or more communication units 1240, one or more input devices 1250, and one or more output devices 1260. The processing unit 1210 may be a physical or virtual processor and may execute various processing according to a program stored in the memory 1220. In a multi-processor system, a plurality of processing units executes computer-executable instructions in parallel to improve the parallel processing capability of the electronic device 1200.

The electronic device 1200 typically includes multiple computer storage media. Such a medium may be any available medium accessible to the electronic device 1200, including but not limited to a volatile and non-volatile medium, a removable and non-removable medium. The memory 1220 may be a volatile memory (e.g., a register, a cache, a random-access memory (RAM)), a non-volatile memory (e.g., a read-only memory (ROM), an electrically erasable programmable read-only memory (EEPROM), a flash memory), or some combination thereof. The storage device 1230 may be a removable or non-removable medium, and may include a machine-readable medium, such as a flash drive, a magnetic disk, or any other medium, which may be used to store information and/or data and may be accessed within the electronic device 1200.

The electronic device 1200 may further include additional removable/non-removable, volatile/non-volatile storage media. Although not shown in FIG. 12, a magnetic disk drive for reading from or writing to a removable, non-volatile magnetic disk (e.g., a “floppy disk”) and an optical disk drive for reading from or writing to a removable, non-volatile optical disk may be provided. In these cases, each drive may be connected to a bus (not shown) by one or more data media interfaces. The memory 1220 may include a computer program product 1225, which has one or more program modules configured to perform various methods or actions of various embodiments of the present disclosure.

The communication unit 1240 enables communication with other electronic devices through a communication medium. Additionally, the functions of the components of the electronic device 1200 may be implemented by a single computing cluster or multiple computing machines that may communicate through a communication connection. Therefore, the electronic device 1200 may operate in a networked environment using logical connections to one or more other servers, network personal computers (PCs), or another network node.

The input device 1250 may be one or more input devices, such as a mouse, a keyboard, a trackball, etc. The output device 1260 may be one or more output devices, such as a display, a speaker, a printer, etc. The electronic device 1200 may also communicate with one or more external devices (not shown) through the communication unit 1240 as required, such as a storage device, a display device, etc., communicate with one or more devices that enable the user to interact with the electronic device 1200, or communicate with any device (such as a network card, a modem, etc.) that enables the electronic device 1200 to communicate with one or more other electronic devices. Such communication may be performed via an input/output (I/O) interface (not shown).

According to an example implementation of the present disclosure, a computer-readable storage medium is provided, on which computer-executable instructions are stored, where the computer-executable instructions are executed by a processor to implement the methods described above. According to an example implementation of the present disclosure, a computer program product is further provided, which is tangibly stored on a non-transitory computer-readable medium and includes computer-executable instructions, and the computer-executable instructions are executed by a processor to implement the methods described above.

Various aspects of the present disclosure are described herein with reference to flowcharts and/or block diagrams of the methods, apparatuses, devices, and computer program products implemented according to the present disclosure. It should be understood that each block of the flowcharts and/or block diagrams and the combination of blocks in the flowcharts and/or block diagrams may be implemented by computer-readable program instructions.

These computer-readable program instructions may be provided to processing units of a general-purpose computer, a special-purpose computer, or other programmable data processing apparatus, so as to produce a machine, such that the instructions, when executed by the processing unit of the computer or the processing unit of the other programmable data processing apparatus, produce the apparatus for implementing the functions/actions specified in one or more blocks in the flowcharts and/or block diagrams. These computer-readable program instructions may also be stored in a computer-readable storage medium. These instructions enable the computer, the programmable data processing apparatus, and/or other devices to work in a specific manner, such that the computer-readable medium storing the instructions includes an article of manufacture, which includes instructions for implementing various aspects of the functions/actions specified in one or more blocks in the flowcharts and/or block diagrams.

The computer-readable program instructions may be loaded onto the computer, the other programmable data processing apparatus, or the other device, such that a series of operation steps are executed on the computer, the other programmable data processing apparatus, or the other device to produce a computer-implemented process, such that the instructions executed on the computer, the other programmable data processing apparatus, or the other device implement the functions/actions specified in one or more blocks in the flowcharts and/or block diagrams.

The flowcharts and block diagrams in the drawings show possible architectures, functions, and operations of the system, method, and computer program product according to multiple implementations of the present disclosure. In this regard, each block in the flowchart or block diagram may represent a part of a module, a program segment, or an instruction. The part of the module, program segment, or instruction contains one or more executable instructions for implementing specified logic functions. In some alternative implementations, the functions marked in the blocks may also occur in a different order than those marked in the drawings. For example, two consecutive blocks may actually be executed basically in parallel, and sometimes they may be executed in a reverse order, depending on the functions involved. It should also be noted that each block in the block diagram and/or flowchart and the combination of blocks in the block diagram and/or flowchart may be implemented by a dedicated hardware-based system that performs specified functions or actions, or may be implemented by a combination of dedicated hardware and computer instructions.

Various implementations of the present disclosure have been described above, and the above description is exemplary and not exhaustive, and is not limited to the disclosed implementations. Many modifications and changes are obvious to ordinary technicians in this technical field without departing from the scope and spirit of the described implementations. The choice of terms used herein is intended to best explain the principles, practical applications, or improvements of the technologies in the market of the implementations, or enable other ordinary technicians in this technical field to understand the implementations disclosed herein.

1. A method for information processing, comprising:
obtaining first information input by a target object for a first processing entity; and
generating second information based on the first information and historical interaction information between the target object and the first processing entity, as a reply of the first processing entity to the first information,
wherein generating the second information comprises:
determining a target data range corresponding to the target object; and
generating the second information based on the historical interaction information, the first information, and the target data range.

2. The method according to claim 1, further comprising:
obtaining first interaction information between the target object and the first processing entity in a first tool of a plurality of tools;
obtaining second interaction information between the target object and the first processing entity in a second tool of the plurality of tools; and
determining the historical interaction information based at least on the first interaction information and the second interaction information.

3. The method according to claim 2, wherein the plurality of tools comprises a plurality of components in an office suite.

4. The method according to claim 2, wherein interaction information between the target object and the first processing entity in the plurality of tools is stored in association with the target object.

5. The method according to claim 1, wherein generating the second information based on the first information and the historical interaction information comprises:
processing the first information based on the historical interaction information, to generate third information;
providing the third information for a second processing entity, the second processing entity being different from the first processing entity; and
generating the second information based on a processing result of the second processing entity for the third information.

6. The method according to claim 5, wherein the third information comprises guidance information, and the second processing entity comprises a target model.

7. The method according to claim 5, wherein processing the first information to generate the third information comprises:
determining, from the historical interaction information, a group of associated historical interaction information associated with the first information; and
generating the third information based on the first information and the group of associated historical interaction information.

8. The method according to claim 7, wherein the third information is generated further based on policy information corresponding to the first information, the policy information at least indicating a policy for instructing the second processing entity to process the first information.

9. (canceled)

10. The method according to claim 9, wherein the target data range is determined based at least on a first data range corresponding to a permission of the target object.

11. The method according to claim 9, wherein the target data range is determined based at least on a second data range corresponding to configuration information of the target object, the configuration information at least indicating a data range that the target object permits the first processing entity to access.

12. The method according to claim 1, wherein the target object comprises a user or an organization, and the first processing entity is provided as a digital assistant corresponding to the user or the organization.

13. The method according to claim 12, wherein the digital assistant is provided as a target contact of the user or the organization in a chat tool.

14. The method according to claim 13, wherein the target contact is presented in a contact list corresponding to the user or the organization.

15. The method according to claim 14, wherein the target contact is presented at a predetermined position in the contact list.

16. The method according to claim 13, further comprising:
causing the second information to be provided in a chat interface corresponding to the target contact.

17. The method according to claim 16, wherein a target chat corresponding to the chat interface is fixedly presented at a predetermined position in a chat list of the user or the organization.

18. The method according to claim 16, wherein the chat interface is further configured to present interaction information between the user or the organization and the digital assistant in at least one office component other than the chat tool.

19-21. (canceled)

22. A method for information processing, comprising:
obtaining first information input by a target object for a first processing entity;
processing the first information based on historical interaction information between the target object and the first processing entity, to generate third information;
providing the third information for a second processing entity, the second processing entity being different from the first processing entity; and
generating second information based on a processing result of the second processing entity for the third information, as a reply of the first processing entity to the first information.

23-24. (canceled)

25. The method according to claim 22, wherein the third information is generated further based on policy information corresponding to the first information, the policy information at least indicating a policy for instructing the second processing entity to process the first information.

26-28. (canceled)

29. A method for message processing, comprising:
obtaining at least one chat message between a target object and a first processing entity in a first component of an office suite; and
presenting, in a second component of the office suite, a chat interface between the target object and the first processing entity, the chat interface displaying at least a portion of the at least one chat message.

30-43. (canceled)
